(19) United States
(12) Patent Application Publication
(10) Pub. No.: US 2006/0107167 A1
(43) Pub. Date: May 18, 2006

(54) Multiple antenna communication system using automatic repeat request error correction scheme

(75) Inventors: Hong-Sil Jeong, Seoul (KR); Chan-Byoung Chae, Seoul (KR); Sung-Ryul Yun, Suwon-si (KR); Won-Il Roh, Yongin-si (KR); Jeong-Tae Oh, Yongin-si (KR); Kyun-Byoung Ko, Hwasung-si (KR); Young-Ho Jung, Seoul (KR); Seung-Hoon Nam, Seoul (KR); Jae-Hak Chung, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/280,702

(22) Filed: Nov. 16, 2005

(30) Foreign Application Priority Data
Nov. 16, 2004 (KR) 2004-0093714
Dec. 27, 2004 (KR) 2004-0112659

(51) Int. Cl. G08C 25/02; H04L 1/18

(52) U.S. Cl. 714/748

(57) ABSTRACT

An Automatic Repeat reQuest (ARQ) error correction transmitting apparatus and method in a multiple antenna system are provided. In the ARQ error correction apparatus, a serial-to-parallel converter converts serial input data to parallel data, a retransmission processor determines a permutation transmission mode with respect to an initial transmission mode, in response to a retransmission request fed back from a receiver, and an STBC encoder STBC-encodes the parallel data and transmits the STBC-coded data through the transmit antennas according to the permutation transmission mode.

### PRIORITY

This application claims priority under 35 U.S.C. § 119 to applications entitled “Multiple Antenna Communication System Using Automatic Repeat Request Error Correction Scheme” filed in the Korean Intellectual Property Office on Nov. 16, 2004 and assigned Serial No. 2004-93714 and “Multiple Antenna Communication System Using Automatic Repeat Request Error Correction Scheme” filed in the Korean Intellectual Property Office on Dec. 27, 2004 and assigned Serial No. 2004-112659, the contents of both of which are incorporated herein by reference.

### BACKGROUND OF THE INVENTION

1. Field of the Invention

The present invention relates generally to an error correction apparatus and method in a multiple antenna communication system, and in particular, to an Automatic Repeat reQuest (ARQ) error correction apparatus and method for, upon receipt of a retransmission request because of errors in transmitted data, retransmitting the data in a permutation mode by antenna diversity, and a transmission apparatus and method using the same in a multiple antenna system.

That is, the present invention is intended to provide a method of constructing a retransmission symbol sequence in a manner that provides antenna diversity, upon receipt of a retransmission request from a receiver in order to implement a high-quality, high-reliability communication system.

2. Description of the Related Art

The basic issue in communication is how efficiently and reliably data can be transmitted on channels. The demand exists for a high-speed communication system capable of processing and transmitting a variety of information including video and wireless data in addition to the traditional early-stage voice service. Further, increasing system efficiency using an appropriate channel coding scheme is a requisite for future-generation multimedia mobile communication systems now under active study.

Generally, in the wireless channel environment of a mobile communication system, unlike that of a wired channel environment, a transmission signal inevitably experiences loss due to several factors such as multipath interference, shadowing, wave attenuation, time-variant noise, and fading. The resulting information loss causes a severe distortion to the actual transmission signal, degrading the whole system performance. In order to reduce the information loss, many error control techniques are usually adopted depending on the characteristics of channels to thereby increase system reliability. The basic error control technique uses an error correction code.

The main error control techniques used in communication systems are Forward Error Correction (FEC) and ARQ. The FEC is a way of transmitting an error correction code from a transmitter and correcting errors in received information at a receiver. Since the FEC is used without a feedback channel that informs the transmitter about the success or failure of information reception, the receiver, if it fails in error correction, gives wrong information to its user. On the other hand, the ARQ is more reliable than the FEC because it uses a Cyclic Redundancy Check (CRC) code having excellent error detection ability. The receiver, if detecting errors in received information, requests data retransmission from the transmitter.

Classic ARQ schemes used in the communication systems include Stop and Wait (SW), Go-Back-N (GBN), and Selective Repeat (SR).

FIG. 1A illustrates data transmission from a transmitter using the SW ARQ scheme. Referring to FIG. 1A, after transmitting one information vector, the transmitter waits without transmitting the next information vector until receiving a response from the receiver. The receiver checks errors in the received information vector using an error detection code. In the absence of errors, the receiver transmits an ACKnowledgement (ACK) signal to the transmitter, whereas in the presence of errors, it transmits a Negative AcKnowledgement (NAK) signal to the transmitter. Upon receipt of the ACK signal, the transmitter transmits the next information vector, and upon receipt of the NAK signal, it retransmits the previous information vector. Despite the advantage of simple system configuration, the SW ARQ scheme is inefficient in view of non-continuous information transmission involving idle time.

FIG. 1B illustrates data transmission from a transmitter using the GBN ARQ scheme. Referring to FIG. 1B, the transmitter transmits successive information vectors without waiting for a response from the receiver. The time required to receive a response for an information vector from the receiver after transmitting the information vector from the transmitter is called “round-trip delay”. During the round-trip delay, the transmitter transmits other (N−1) information vectors. The receiver transmits an ACK signal in the absence of errors in a received information vector and a NAK signal to the transmitter in the presence of errors, without using the subsequently received successive (N−1) information vectors irrespective of presence or absence of errors in them. Upon receipt of the NAK signal, the transmitter retransmits the corresponding information vector, together with the successive (N−1) information vectors transmitted for the round-trip delay. If the round-trip delay is long, a large number of error-free information vectors are not used at the receiver and retransmitted from the transmitter. Thus, the GBN ARQ is also inefficient.

FIG. 1C illustrates data transmission from a transmitter using the SR ARQ scheme. Referring to FIG. 1C, the transmitter transmits information vectors successively. Upon receipt of a NAK signal from the receiver, the transmitter retransmits only a corresponding information vector. Although the SR ARQ scheme is superior to the above-described other schemes in terms of efficiency, it suffers the highest complexity in real implementation.

The above ARQ schemes can be applied to a Multiple-Input Multiple-Output (MIMO) system. MIMO is an antenna diversity scheme using a plurality of transmit antennas and a plurality of receive antennas to mitigate the effect of multipath fading in a wireless communication system. The MIMO system expands time-domain coding to space-domain coding by transmitting a Space-Time Coding (STC) signal through a plurality of transmit antennas. Thus, it achieves a low error rate.

As stated above, it is possible to use ARQ error correction for the MIMO system. In this context, the term “retransmission MIMO system” used herein means a MIMO system using an ARQ error correction scheme.

FIG. 2 is a block diagram of a transmitter in a MIMO communication system using an ARQ error correction scheme. Referring to FIG. 2, an encoder 200 encodes information data for transmission. One of various channel encoders is available as the encoder 200. A modulator 202 modulates the coded data in a predetermined modulation scheme such as Binary Phase Shift Keying (BPSK), Quadrature Phase Shift Keying (QPSK), Quadrature Amplitude Modulation (QAM), Pulse Amplitude Modulation (PAM), or Phase Shift Keying (PSK).

A serial-to-parallel (S/P) converter 204 parallelizes the serial modulation symbols and provides the parallel modulation symbols to a Space Time Block Coding (STBC) encoder (or a Space Time Frequency Block Coding (STFBC) encoder) 206.

The configuration of the STBC encoder 206 depends on the number of transmit antennas 208 to 214 and the diversity scheme used. For four transmit antennas, the following coding matrices are available to the STBC encoder 206 as Equation (1).

$$A = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ] B = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ] C = [ \begin{matrix}{s}_{1} \\ {s}_{2} \\ {s}_{3} \\ {s}_{4}\end{matrix} ] \qquad ( 1 )$$

where the rows in each coding matrix represent the respective transmit antennas, and the columns represent time intervals in which the four symbols are transmitted.

The matrix A is a coding matrix for transmitting symbols through four transmit antennas. s₁, s₂, s₃, s₄ are four input symbols to be transmitted. Symbols, s₁ and s₂, are transmitted through the first and second antennas 208 and 210, respectively in a first time interval, and −s*₂ and s*₁ through the first and second antennas 208 and 210, respectively in a second time interval. Symbols, s₃ and s₄, are transmitted through the third and fourth antennas 212 and 214, respectively in a third time interval, and −s*₄ and s*₃ through the third and fourth antennas 212 and 214, respectively in a fourth time interval.

The matrix B is another coding matrix for transmitting symbols through four transmit antennas. The eight input symbols s₁, s₂, s₃, s₄, s₅, s₆, s₇, s₈ are to be transmitted. Symbols, s₁, s₂, s₃, s₄ are transmitted through the respective four antennas 208 to 214 in the first time interval, and −s*₂, s*₁, −s*₄, s*₃, through the respective four antennas 208 to 214 in the second time interval. Symbols, s₅, s₆, s₇, s₈ are transmitted through the four respective antennas 208 to 214 in the third time interval, and −s*₇, −s*₈, s*₅, s*₆ through the four respective antennas 208 to 214 in the fourth time interval.

The matrix C is a third coding matrix for transmitting symbols through four transmit antennas. The four input symbols s₁, s₂, s₃, s₄ are to be transmitted. They are all transmitted through the four respective antennas 208 to 214 in the first time interval.

The receiver can request retransmission in the retransmission MIMO system. A retransmission processor 216 receives an ACK/NAK signal from the receiver and the encoder 200 and the STBC encoder 206 operate according to the ACK/NAK signal.

In a conventional ARQ error correction scheme using the matrix C of Equation (1), that is, using spatial multiplexing in the MIMO system, the transmitter initially transmits symbols using the coding matrix of Equation (2).

$${S}_{4}^{( 0 )} = [ \begin{matrix}{s}_{1} \\ {s}_{2} \\ {s}_{3} \\ {s}_{4}\end{matrix} ] \qquad ( 2 )$$

For an odd-numbered retransmission, that is, upon receipt of an odd-numbered retransmission request, the coding matrix is represented as Equation (3).

$${S}_{4}^{( odd )} = [ \begin{matrix}{s}_{2}^{*} \\ - {s}_{1}^{*} \\ {s}_{4}^{*} \\ - {s}_{3}^{*}\end{matrix} ] \qquad ( 3 )$$

For an even-numbered retransmission, that is, upon receipt of an even-numbered retransmission request, the coding matrix is Equation (4).

$${S}_{4}^{( even )} = [ \begin{matrix}{s}_{1} \\ {s}_{2} \\ {s}_{3} \\ {s}_{4}\end{matrix} ] \qquad ( 4 )$$

For three transmit antennas in the spatial multiplexing mode, the transmitter transmits the following initial transmission symbols according to Equation (5).

$${S}_{3}^{( 0 )} = [ \begin{matrix}{s}_{1} \\ {s}_{2} \\ {s}_{3}\end{matrix} ] \qquad ( 5 )$$

For an odd-numbered retransmission, the symbols are transmitted according to Equation (6).

$${S}_{3}^{( odd )} = [ \begin{matrix}{s}_{2}^{*} \\ - {s}_{1}^{*} \\ {s}_{3}^{*}\end{matrix} ] \qquad ( 6 )$$

For an even-numbered retransmission, the symbols are transmitted according to Equation (7).

$${S}_{3}^{( even )} = [ \begin{matrix}{s}_{1} \\ {s}_{2} \\ {s}_{3}\end{matrix} ] \qquad ( 7 )$$

In another conventional ARQ error correction scheme using the matrix B of Equation (1), that is, using a hybrid mode in the MIMO system, initial transmission symbols for four transmit antennas are designated according to Equation (8)

$${S}_{4}^{( 0 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ] \qquad ( 8 )$$

For an odd-numbered retransmission, the transmitter transmits the symbols according to Equation (9).

$${S}_{4}^{( odd )} = [ \begin{matrix}{s}_{1} & - {s}_{2}^{*} & {s}_{5} & - {s}_{7}^{*} \\ {s}_{2} & {s}_{1}^{*} & - {s}_{6} & {s}_{8}^{*} \\ - {s}_{3} & {s}_{4}^{*} & {s}_{7} & {s}_{5}^{*} \\ - {s}_{4} & - {s}_{3}^{*} & - {s}_{8} & - {s}_{6}^{*}\end{matrix} ] \qquad ( 9 )$$

For an even-numbered retransmission, the transmitter transmits the symbols according to Equation (10).

$${S}_{4}^{( even )} = [ \begin{matrix}{s}_{3} & - {s}_{4}^{*} & {s}_{6} & - {s}_{8}^{*} \\ {s}_{4} & {s}_{3}^{*} & {s}_{5} & - {s}_{7}^{*} \\ {s}_{1} & - {s}_{2}^{*} & {s}_{8} & {s}_{6}^{*} \\ {s}_{2} & {s}_{1}^{*} & {s}_{7} & {s}_{5}^{*}\end{matrix} ] \qquad ( 10 )$$

The same coding matrix patterns apply to a diversity mode using the matrix A of Equation (1) for ARQ error correction in the MIMO system.

As described above, the STBC encoder 206 transmits a plurality of input symbols through a plurality of transmit antennas in a plurality of time intervals according to a predetermined coding matrix. When the receiver requests a retransmission, the STBC encoder 206 operates differently depending on whether the retransmission request is odd-numbered or even-numbered. A retransmission processor determines a permutation transmission mode with respect to an initial transmission mode in response to a retransmission request fed back from the receiver.

FIG. 3 is a block diagram of a receiver in the conventional retransmission MIMO mobile communication system. The receiver is the counterpart of the transmitter illustrated in FIG. 2. The receiver includes a plurality of receive antennas 300 to 304, an STBC decoder 306 (or an STFBC decoder when an STFBC encoder is used in the transmitter), a channel estimator 308, a detector 310, a decoder 312, and a CRC detector 314 for error detection.

Referring to FIG. 3, signals transmitted through the four transmit antennas 208 to 214 from the transmitter are received at the first to P^{th} receive antennas 300 to 304. The first to P^{th} receive antennas 300 to 304 provide their received signals to the channel estimator 308 and the STBC decoder 306. The channel estimator 308 estimates channel coefficients representing channel gains between the transmit antennas 208 to 214 and the receive antennas 300 to 304 using the received signals and outputs the channel coefficients to the STBC decoder 306. The STBC decoder 306 estimates the input data of the STBC encoder 206 of the transmitter using the received signals. The detector 310 achieves the hypotheses of the transmitted symbols using the STBC decoder output and the channel coefficients. The hypotheses are created by computing a decision statistic over all possible symbols that can be transmitted from the transmitter. The decoder 312 decodes the hypotheses in a predetermined decoding method corresponding to a coding method used in the encoder 200 of the transmitter, thereby recovering the original information data bits. The CRC detector 314 checks the CRC of the decoded data. Upon detection of errors, the CRC detector 314 transmits a NAK signal to the transmitter, requesting retransmission.

Since a retransmission signal is transmitted through a different antenna from that of an initial transmission signal in the above-described methods, antenna diversity and time diversity are achieved and data transmission is carried out in the Alamouti scheme. Therefore, data reception is facilitated at the receiver. Meanwhile, signal decoding in the Alamouti scheme at the receiver is viable only if no channel variation occurs during the retransmission. However, when the receiver requests a retransmission in a real communication system, the retransmission takes place a few frames after the retransmission request and thus the channel may vary over the frames, which makes the Alamouti decoding difficult. Moreover, implementation of the Alamouti scheme increases the complexity of the receiver.

That is, if retransmission is carried out in the Alamouti scheme for a retransmission request from the receiver, the channel varies over the time period from the retransmission request to the retransmission. Thus, it is difficult to achieve an additional gain from the Alamouti scheme. Nonetheless, the transmitter needs to inverse (−) or conjugate (*) a transmission signal and the receiver needs to receive signals according to the Alamouti scheme. The resulting use of additional processors increases hardware complexity.

### SUMMARY OF THE INVENTION

An object of the present invention is to substantially solve at least the above problems and/or disadvantages and to provide at least the advantages below. Accordingly, an object of the present invention is to provide an ARQ error correction transmitter and transmission method for retransmitting data without errors in response to a retransmission request from a receiver, without the need for an additional processor in a communication system using a plurality of transmit antennas.

Another object of the present invention is to provide an ARQ error correction transmitter and transmission method for retransmitting data without errors in a permutation transmission mode using antenna diversity in response to a retransmission request from a receiver in a communication system using a plurality of transmit antennas.

The above objects are achieved by providing an ARQ error correction transmitting apparatus and method in a multiple antenna system.

According to one aspect of the present invention, in a transmitter in a communication system using a plurality of transmit antennas, a serial-to-parallel converter converts serial input data to parallel data, a retransmission processor determines a permutation transmission mode with respect to an initial transmission mode, in response to a retransmission request fed back from a receiver, and an STBC encoder STBC-encodes the parallel data and transmits the STBC-coded data through the transmit antennas according to the permutation transmission mode.

According to another aspect of the present invention, in a transmission method in a communication system using a plurality of transmit antennas, input data is encoded in a predetermined coding scheme and modulated in a predetermined modulation scheme. The serial modulated data is converted to parallel data. In response to a retransmission request fed back from a receiver, a permutation transmission mode with respect to an initial transmission mode is determined. The parallel data is STBC-encoded and transmitted through the transmit antennas according to the permutation transmission mode.

### BRIEF DESCRIPTION OF THE DRAWINGS

The above and other objects, features and advantages of the present invention will become more apparent from the following detailed description when taken in conjunction with the accompanying drawings in which:

FIG. 1A illustrates a data transmission method in a transmitter using an SW ARQ scheme;

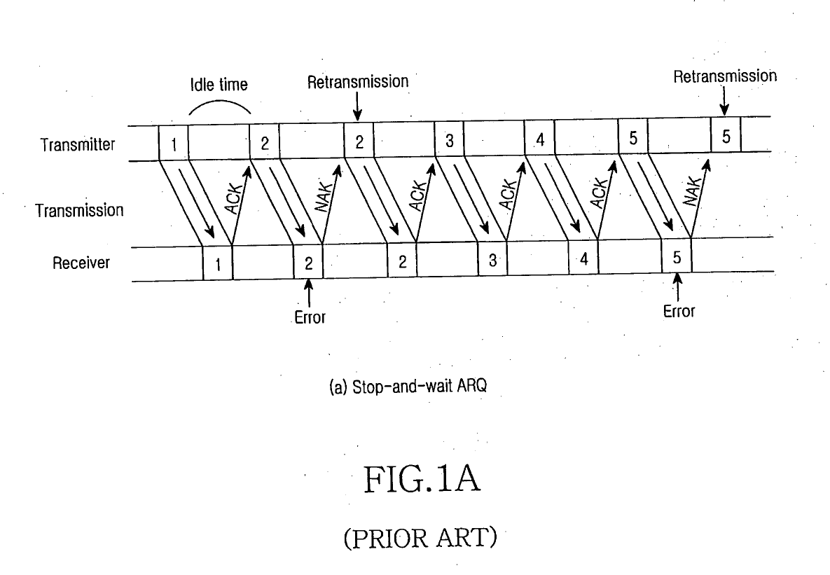

FIG. 1B illustrates a data transmission method in a transmitter using a GBN ARQ scheme;

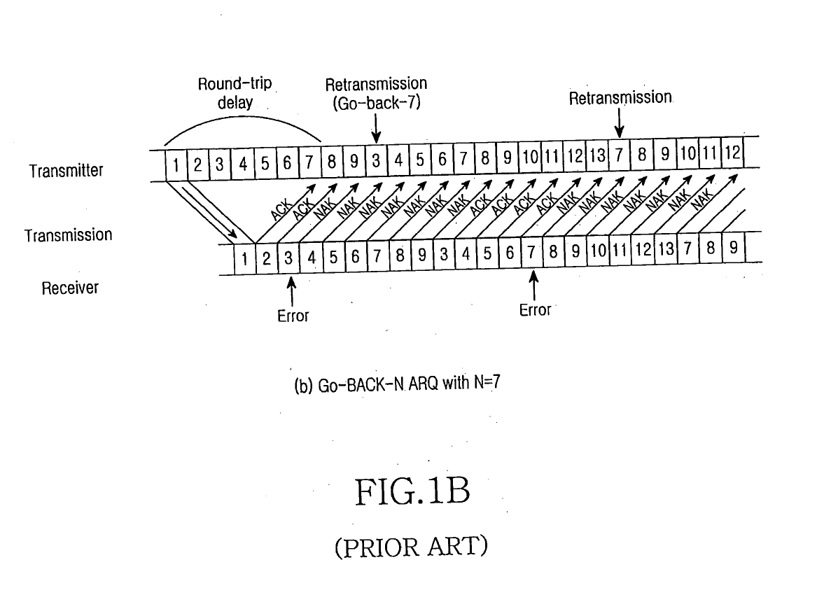

FIG. 1C illustrates a data transmission method in a transmitter using an SR ARQ scheme;

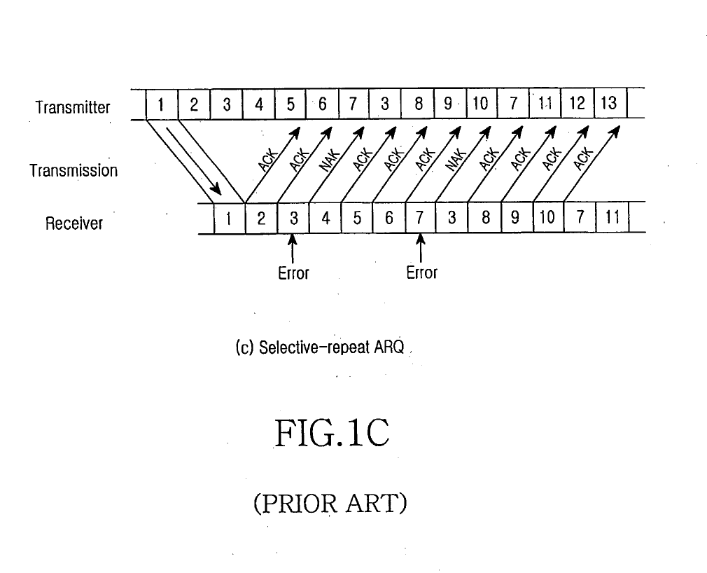

FIG. 2 is a block diagram of a transmitter in a MIMO communication system using an ARQ error correction scheme;

FIG. 3 is a block diagram of a receiver in the MIMO communication system using the ARQ error correction scheme; and

FIG. 4 is a flowchart illustrating a data transmission method in a MIMO communication system using an ARQ error correction scheme according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

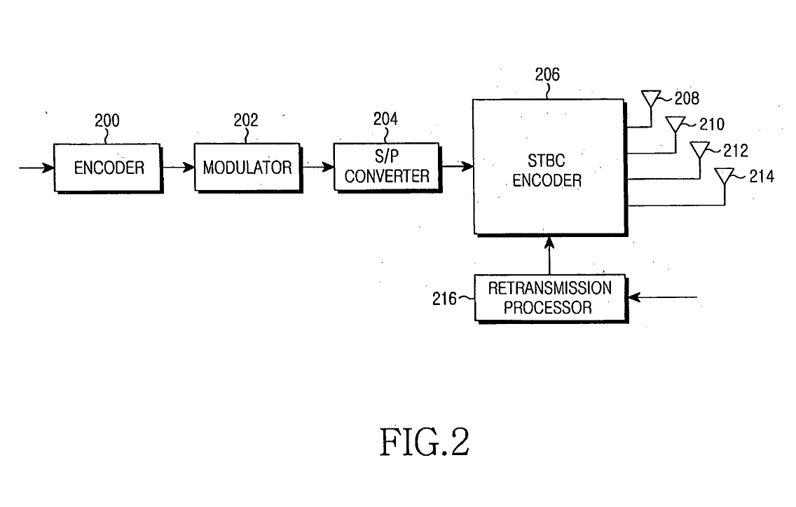

FIG. 2 is a block diagram of a transmitter in a MIMO communication system using an ARQ error correction scheme according to the present invention. The transmitter is the same in configuration as the conventional transmitter using an ARQ error correction scheme. How the transmitter operates will be described below in great detail.

Data Transmission in Spatial Multiplexing Mode

The matrix C of Equation (1), representing an STC at rate 4 for four transmit antennas, is an example of data transmission in the spatial multiplexing mode in the MIMO system.

For two transmit antennas (at rate 2, i.e. two symbols per unit time), the transmitter initially transmits symbols using the coding matrix of Equation (11).

$${S}_{2}^{( 0 )} = [ \begin{matrix}{s}_{1} \\ {s}_{2}\end{matrix} ] \qquad ( 11 )$$

For an odd-numbered retransmission, the transmitter transmits symbols S₂^{(odd)} and for an even-numbered retransmission, it transmits symbols S₂^{(even)}, both according to Equation (12).

$${S}_{2}^{( odd )} = [ \begin{matrix}{s}_{2} \\ {s}_{1}\end{matrix} ] {S}_{2}^{( even )} = [ \begin{matrix}{s}_{1} \\ {s}_{2}\end{matrix} ] \qquad ( 12 )$$

For three transmit antennas, initial transmission symbols are given as Equation (13).

$${S}_{3}^{( 0 )} = [ \begin{matrix}{s}_{1} \\ {s}_{2} \\ {s}_{3}\end{matrix} ] \qquad ( 13 )$$

For a first retransmission, the transmitter permutes the sequence of the initial transmission symbols by Equation (14).
S₃⁽¹⁾=Π₍₁₎(S₃⁽⁰⁾) (14)

For example, the permutation results the following retransmission symbols according to Equation (15).

$${S}_{3}^{( 1 )} = [ \begin{matrix}{s}_{2} \\ {s}_{3} \\ {s}_{1}\end{matrix} ] \qquad ( 15 )$$

For a j^{th} retransmission, the transmitter produces the retransmission symbols by permuting the sequence of the initial transmission symbols in Equation (13) by Equation (16).
S₃^{(j)}=Π₍ⱼ₎(S₃⁽⁰⁾) (16)

The above permutation can be easily expanded to more antennas.

For N_{T} transmit antennas, therefore, the transmitter creates the initial transmission symbols using the coding matrix given by Equation (17).

$${S}_{{N}_{T}}^{( 0 )} = [ \begin{matrix}{s}_{1} \\ {s}_{2} \\ ⋮ \\ {s}_{{N}_{T}}\end{matrix} ] \qquad ( 17 )$$

Upon receipt of a j^{th} retransmission request, the transmitter produces the retransmission symbols by permuting the sequence of the above initial transmission symbols by Equation (18).
S_{N}_{_{T}}^{(j)}=Π₍ⱼ₎(S_{N}_{_{T}}⁽⁰⁾) (18)

Apparently, Π₍ⱼ₎ is designed to be different from Π₍ᵢ₎(1 i<j) such that the same signal is retransmitted through a different antenna from that used for the previous transmission. For three transmit antennas, Π₍ⱼ₎ is given, for example, by Equation (19).

$${Π}_{( 1 )} = {Π}_{1 mod 3 )} = [ \begin{matrix}0 & 1 & 0 \\ 0 & 0 & 1 \\ 1 & 0 & 0\end{matrix} ] \\ {Π}_{( 2 )} = {Π}_{( 2 mod 3 )} = [ \begin{matrix}0 & 0 & 1 \\ 1 & 0 & 0 \\ 0 & 1 & 0\end{matrix} ] \\ {Π}_{( 3 )} = {Π}_{( 3 mod 3 )} = [ \begin{matrix}1 & 0 & 0 \\ 0 & 1 & 0 \\ 0 & 0 & 1\end{matrix} ] \qquad ( 19 )$$

Data Transmission in Diversity Mode

In the diversity mode, an STC is transmitted through four transmit antennas at rate 1 (i.e. one symbol per unit time) in the MIMO system. The STC is expressed as Equation (20).

$${A}_{4}^{( 0 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ] \qquad ( 20 )$$

Upon receipt of a (4n+1)^{th} retransmission request (n is an integer), the retransmission symbols are expressed as Equation (21).

$${A}_{4}^{( 4 n + 1 )} = [ \begin{matrix}0 & 0 & {s}_{3} & - {s}_{4}^{*} \\ 0 & 0 & {s}_{4} & {s}_{3}^{*} \\ {s}_{1} & - {s}_{2}^{*} & 0 & 0 \\ {s}_{2} & {s}_{1}^{*} & 0 & 0\end{matrix} ] \qquad ( 21 )$$

Upon receipt of a (4n+2)^{th} retransmission request, the transmitter transmits the retransmission symbols according to Equation (22).

$${A}_{4}^{( 4 n + 2 )} = [ \begin{matrix}0 & 0 & {s}_{3} & - {s}_{4}^{*} \\ {s}_{1} & - {s}_{2}^{*} & 0 & 0 \\ 0 & 0 & {s}_{4} & {s}_{3}^{*} \\ {s}_{2} & {s}_{1}^{*} & 0 & 0\end{matrix} ] \qquad ( 22 )$$

Upon receipt of a (4n+3)^{th} retransmission request, the transmitter transmits the following retransmission symbols according to Equation (23).

$${A}_{4}^{( 4 n + 3 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & 0 & 0 \\ 0 & 0 & {s}_{4} & {s}_{3}^{*}\end{matrix} ] \qquad ( 23 )$$

Upon receipt of a (4n+4)^{th} retransmission request, the retransmission symbols are expressed by Equation (24).

$${A}_{4}^{( 4 n + 4 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ] \qquad ( 24 )$$

For retransmissions, only the coding matrices A₄⁽⁴ⁿ⁺¹⁾ and A₄⁽⁴ⁿ⁺⁴⁾ rather than the above four coding matrices can be used.

For three antennas, the coding matrix for an initial transmission is expressed Equation (25):

$${A}_{3}^{( 0 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ] \qquad ( 25 )$$

which represents an STC for three antennas at rate 1. In this case, upon receipt of a (3n+1)^{th} retransmission request, the retransmission symbols are expressed by Equation (26).

$${A}_{3}^{( 3 n + 1 )} = [ \begin{matrix}{s}_{1} & - {s}_{2}^{*} & {s}_{3} & - {s}_{4}^{*} \\ {s}_{2} & - {s}_{1}^{*} & 0 & 0 \\ 0 & 0 & {s}_{4} & {s}_{3}^{*}\end{matrix} ] \qquad ( 26 )$$

Upon receipt of a (3n+2)^{th} retransmission request, the transmitter transmits the retransmission symbols according to Equation (27).

$${A}_{3}^{( 3 n + 2 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & {s}_{4} & {s}_{3}^{*}\end{matrix} ] \qquad ( 27 )$$

Upon receipt of a (3n+3)^{th} retransmission request, the transmitter uses the coding matrix of Equation (28).

$${A}_{3}^{( 3 n + 3 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ] \qquad ( 28 )$$

Data Transmission in Hybrid Mode

An STC for four transmit antennas at rate 2 (two symbols per unit time) is given as Equation (29).

$${B}_{4}^{( 0 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ] \qquad ( 29 )$$

Upon receipt of a (4n+1)^{th} retransmission request (n is an integer), the retransmission symbols are transmitted according to Equation (30).

$${B}_{4}^{( 4 n + 1 )} = [ \begin{matrix}{s}_{3} & - {s}_{4}^{*} & {s}_{7} & {s}_{5}^{*} \\ {s}_{4} & {s}_{3}^{*} & {s}_{8} & {s}_{6}^{*} \\ {s}_{1} & - {s}_{2}^{*} & {s}_{5} & - {s}_{7}^{*} \\ {s}_{2} & {s}_{1}^{*} & {s}_{6} & - {s}_{8}^{*}\end{matrix} ] \qquad ( 30 )$$

Upon receipt of a (4n+2)^{th} retransmission request, the transmitter transmits the retransmission symbols according to Equation (31).

$${B}_{4}^{( 4 n + 2 )} = [ \begin{matrix}{s}_{1} & - {s}_{2}^{*} & {s}_{5} & - {s}_{7}^{*} \\ {s}_{3} & - {s}_{4}^{*} & {s}_{7} & {s}_{5}^{*} \\ {s}_{2} & {s}_{1}^{*} & {s}_{6} & - {s}_{8}^{*} \\ {s}_{4} & {s}_{3}^{*} & {s}_{8} & {s}_{6}^{*}\end{matrix} ] \qquad ( 31 )$$

Upon receipt of a (4n+3)^{th} retransmission request, the transmitter transmits the retransmission symbols according to Equation (32).

$${B}_{4}^{( 4 n + 3 )} = [ \begin{matrix}{s}_{3} & - {s}_{4}^{*} & {s}_{7} & {s}_{5}^{*} \\ {s}_{1} & - {s}_{2}^{*} & {s}_{5} & - {s}_{7}^{*} \\ {s}_{4} & {s}_{3}^{*} & {s}_{8} & {s}_{6}^{*} \\ {s}_{2} & {s}_{1}^{*} & {s}_{6} & - {s}_{8}^{*}\end{matrix} ] \qquad ( 32 )$$

Upon receipt of a (4n+4)^{th} retransmission request, the retransmission symbols are given according to Equation (33).

$${B}_{4}^{( 4 n + 4 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ] \qquad ( 33 )$$

For retransmission, only the coding matrices B₄⁽⁴ⁿ⁺¹⁾ and B₄⁽⁴ⁿ⁺⁴⁾ rather than the above four coding matrices can be used.

For three antennas, the coding matrix for an initial transmission is given by Equation (34):

$${B}_{3}^{( 0 )} = [ \begin{matrix}{s}_{1} & - {s}_{2}^{*} & {s}_{5} & - {s}_{6}^{*} \\ {s}_{2} & {s}_{1}^{*} & {s}_{6} & {s}_{5}^{*} \\ {s}_{7} & {s}_{8}^{*} & {s}_{3} & - {s}_{4}^{*}\end{matrix} ] \qquad ( 34 )$$

which represents an STC for three antennas at rate 2.

In this case, upon receipt of a (3n+1)^{th} retransmission request (n is an integer), the retransmission symbols are determined by Equation (35).

$${B}_{3}^{( 3 n + 1 )} = [ \begin{matrix}0 & 1 & 0 \\ 0 & 0 & 1 \\ 1 & 0 & 0\end{matrix} ] {B}_{3}^{( 0 )} \qquad ( 35 )$$

Upon receipt of a (3n+2)^{th} retransmission request, the transmitter transmits the retransmission symbols as determined by Equation (36).

$${B}_{3}^{( 3 n + 2 )} = [ \begin{matrix}0 & 0 & 1 \\ 1 & 0 & 0 \\ 0 & 1 & 0\end{matrix} ] {B}_{3}^{( 0 )} \qquad ( 36 )$$

Upon receipt of a (3n+3)^{th} retransmission request, the transmitter transmits the retransmission symbols as determined by Equation (37).

$${B}_{3}^{( 3 n + 3 )} = [ \begin{matrix}1 & 0 & 0 \\ 0 & 1 & 0 \\ 0 & 0 & 1\end{matrix} ] {B}_{3}^{( 0 )} \qquad ( 37 )$$

According to the above-described ARQ error correction schemes, because the same signal is retransmitted through a different antenna from that used at the previous transmission, the signal has a different fading gain and, consequently, antenna diversity is achieved.

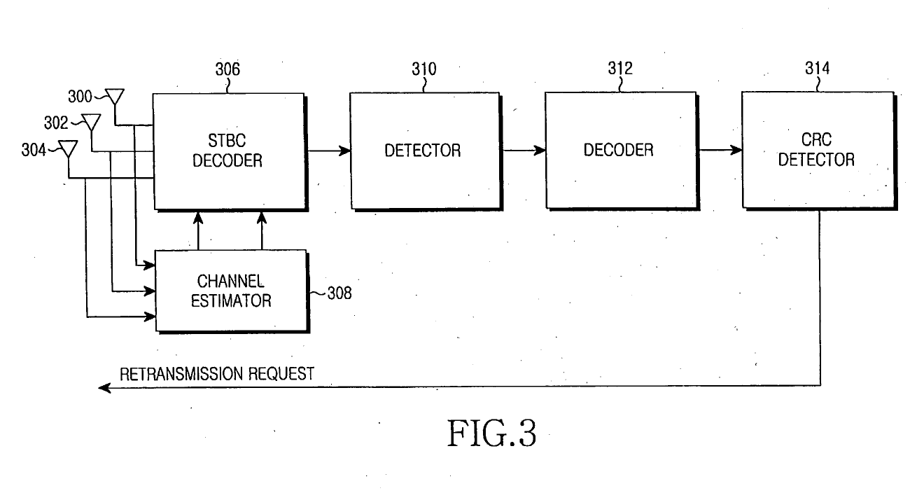

FIG. 3 is a block diagram of a receiver in the MIMO communication system using an ARQ error correction scheme according to the present invention. The receiver is the counterpart of the transmitter illustrated in FIG. 2. The detector 310 estimates a transmitted signal by combining a previous transmitted signal with its retransmission signal. Compared to the conventional ARQ error correction scheme using the Alamouti scheme, signal decoding is enabled without additional operations.

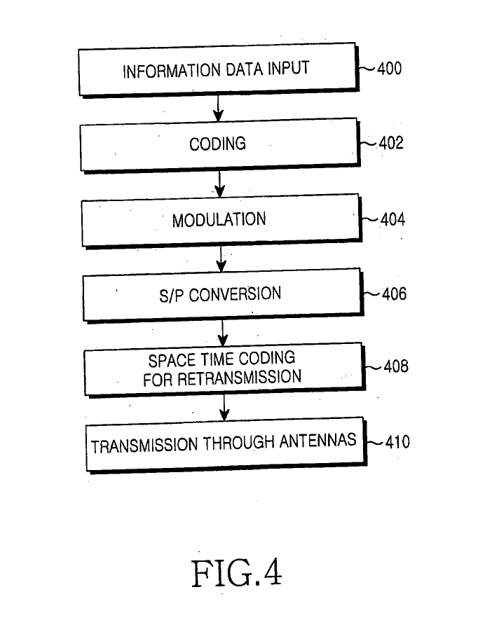

FIG. 4 is a flowchart illustrating a data transmission method for the transmitter in the MIMO communication system using the ARQ error correction scheme, that is, in the ARQ-MIMO communication system according to the present invention.

Referring to FIG. 4, the transmitter receives information data for transmission in step 400, encodes the received information vector in a predetermined coding method in step 402, and modulates the coded data in step 404. For the modulation, BPSK, QPSK, PAM, QAM, or any other modulation scheme is available. In step 406, the serial modulated signal is converted to parallel modulated signals and provided to the STBC encoder (or the STBC encoder). Upon receipt of a retransmission request from the receiver, the transmitter checks the number of the requested retransmission, STBC-encodes (or STBC-encodes) the parallel modulated signals in a permutation mode of an initial transmission mode according to the number of the retransmission, and correspondingly transmits the STBC-coded or STBC-coded data through the antennas in step 410.

Alternatively, the receiver can feed back a permutation transmission mode to the transmitter. The transmitter then STBC-encodes or STBC-encodes data according to the permutation mode and transmits the STBC-coded or STBC-coded data through the respective corresponding transmit antennas.

In accordance with the present invention as described above, upon receipt of a retransmission request from a receiver, data is retransmitted without errors by antenna diversity according to a predetermined improved rule, that is, in a permutation transmission mode with respect to an initial transmission mode. Therefore, a high-speed, high-reliability communication system can be implemented.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmitter in a communication system using a plurality of transmit antennas, comprising:
a serial-to-parallel converter for converting serial input data to parallel data;
a retransmission processor for determining a permutation transmission mode with respect to an initial transmission mode, in response to a retransmission request fed back from a receiver; and
a space-time-block encoder for space-time-block encoding the parallel data and transmitting the space-time-block-coded data through the plurality of transmit antennas according to the permutation transmission mode.

2. The transmitter of claim 1, further comprising an encoder for encoding the serial input data in a predetermined coding scheme and a modulator for modulating the coded data in a predetermined modulation scheme and outputting modulated data to the serial-to-parallel converter.

3. The transmitter of claim 1, wherein if the number of the transmit antennas is N_{T}, a coding matrix for the initial transmission mode is
$${S}_{{N}_{T}}^{( 0 )} = [ \begin{matrix}{s}_{1} \\ {s}_{2} \\ ⋮ \\ {s}_{{N}_{T}}\end{matrix} ]$$
where s₁, s₂ . . . S_{NT} are input symbols.

4. The transmitter of claim 3, wherein upon request for a j^{th} retransmission, a coding matrix for the permutation transmission mode is determined by
S_{N}_{_{T}}^{(j)}=Π₍ⱼ₎(S_{N}_{_{T}}⁽⁰⁾)

5. The transmitter of claim 1, wherein if the number of the transmit antennas is 2, a coding matrix for the initial transmission mode is
$${S}_{2}^{( 0 )} = [ \begin{matrix}{s}_{1} \\ {s}_{2}\end{matrix} ]$$
where s₁ and s₂ are input symbols.

6. The transmitter of claim 5, wherein upon request for an odd-numbered retransmission, a coding matrix for the permutation transmission mode is
$${S}_{2}^{( odd )} = [ \begin{matrix}{s}_{2} \\ {s}_{1}\end{matrix} ]$$
and upon request for an even-numbered retransmission, a coding matrix for the permutation transmission mode is
$${S}_{2}^{( even )} = [ \begin{matrix}{s}_{1} \\ {s}_{2}\end{matrix} ]$$

7. The transmitter of claim 1, wherein if the number of the transmit antennas is 3, a coding matrix for the initial transmission mode is
$${S}_{3}^{( 0 )} = [ \begin{matrix}{s}_{1} \\ {s}_{2} \\ {s}_{3}\end{matrix} ]$$
where s₁, s₂ and s₃ are input symbols.

8. The transmitter of claim 7, wherein upon request for a j^{th} retransmission, a coding matrix for the permutation transmission mode is determined by
S₃^{(j)}=Π₍ⱼ₎(S₃⁽⁰⁾)

9. The transmitter of claim 1, wherein if the number of the transmit antennas is 4, a coding matrix for the initial transmission mode is
$${A}_{4}^{( 0 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ]$$
where s₁, s₂ s₃ and s₄ are input symbols.

10. The transmitter of claim 9, wherein data matrices for the permutation transmission mode are
$${A}_{4}^{( 4 n + 1 )} = [ \begin{matrix}0 & 0 & {s}_{3} & - {s}_{4}^{*} \\ 0 & 0 & {s}_{4} & {s}_{3}^{*} \\ {s}_{1} & - {s}_{2}^{*} & 0 & 0 \\ {s}_{2} & {s}_{1}^{*} & 0 & 0\end{matrix} ]$$
$${A}_{4}^{( 4 n + 2 )} = [ \begin{matrix}0 & 0 & {s}_{3} & - {s}_{4}^{*} \\ {s}_{1} & - {s}_{2}^{*} & 0 & 0 \\ 0 & 0 & {s}_{4} & {s}_{3}^{*} \\ {s}_{2} & {s}_{1}^{*} & 0 & 0\end{matrix} ]$$
$${A}_{4}^{( 4 n + 3 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & 0 & 0 \\ 0 & 0 & {s}_{4} & {s}_{3}^{*}\end{matrix} ]$$
$${A}_{4}^{( 4 n + 4 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ]$$
where A₄⁽⁴ⁿ⁺¹⁾, A₄⁽⁴ⁿ⁺²⁾, A₄⁽⁴ⁿ⁺³⁾ and A₄⁽⁴ⁿ⁺⁴⁾ represent data matrices to be used for the permutation transmission mode, upon request for (4n+1)^{th}, (4n+2)^{th}, (4n+3)^{th}, (4n+4)^{th} retransmissions, and n is an integer.

11. The transmitter of claim 1, wherein if the number of the transmit antennas is 3, a coding matrix for the initial transmission mode is
$${A}_{3}^{( 0 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ]$$
where s₁, s₂ s₃ and s₄ are input symbols.

12. The transmitter of claim 11, wherein data matrices for the permutation transmission mode are
$${A}_{3}^{( 3 n + 1 )} = [ \begin{matrix}{s}_{1} & - {s}_{2}^{*} & {s}_{3} & - {s}_{4}^{*} \\ {s}_{2} & - {s}_{1}^{*} & 0 & 0 \\ 0 & 0 & {s}_{4} & {s}_{3}^{*}\end{matrix} ]$$
$${A}_{3}^{( 3 n + 2 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & {s}_{4} & {s}_{3}^{*}\end{matrix} ]$$
$${A}_{3}^{( 3 n + 3 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ]$$
where A₃⁽³ⁿ⁺¹⁾, A₃⁽³ⁿ⁺²⁾ and A₃⁽³ⁿ⁺³⁾ represent data matrices to be used for the permutation transmission mode, upon request for (3n+1)^{th}, (3n+2)^{th}, and (3n+3)^{th} retransmission, and n is an integer.

13. The transmitter of claim 1, wherein if the number of the transmit antennas is 4, a coding matrix for the initial transmission mode is
$${B}_{4}^{( 0 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ]$$
where s₁, s₂, s₃, s₄, s₅, s₆, s₇, and s₈ are input symbols.

14. The transmitter claim 13, wherein data matrices for the permutation transmission mode are
$${B}_{4}^{( 4 n + 1 )} = [ \begin{matrix}{s}_{3} & - {s}_{4}^{*} & {s}_{7} & {s}_{5}^{*} \\ {s}_{4} & {s}_{3}^{*} & {s}_{8} & {s}_{6}^{*} \\ {s}_{1} & - {s}_{2}^{*} & {s}_{5} & - {s}_{7}^{*} \\ {s}_{2} & {s}_{1}^{*} & {s}_{6} & - {s}_{8}^{*}\end{matrix} ]$$
$${B}_{4}^{( 4 n + 2 )} = [ \begin{matrix}{s}_{1} & - {s}_{2}^{*} & {s}_{5} & - {s}_{7}^{*} \\ {s}_{3} & - {s}_{4}^{*} & {s}_{7} & {s}_{5}^{*} \\ {s}_{2} & {s}_{1}^{*} & {s}_{6} & - {s}_{8}^{*} \\ {s}_{4} & {s}_{3}^{*} & {s}_{8} & {s}_{6}^{*}\end{matrix} ]$$
$${B}_{4}^{( 4 n + 3 )} = [ \begin{matrix}{s}_{3} & - {s}_{4}^{*} & {s}_{7} & {s}_{5}^{*} \\ {s}_{1} & - {s}_{2}^{*} & {s}_{5} & - {s}_{7}^{*} \\ {s}_{4} & {s}_{3}^{*} & {s}_{8} & {s}_{6}^{*} \\ {s}_{2} & {s}_{1}^{*} & {s}_{6} & - {s}_{8}^{*}\end{matrix} ]$$
$${B}_{4}^{( 4 n + 4 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ]$$
where B₄⁽⁴ⁿ⁺¹⁾, B₄⁽⁴ⁿ⁺²⁾, B₄⁽⁴ⁿ⁺³⁾ and B₄⁽⁴ⁿ⁺⁴⁾ represent data matrices to be used for the permutation transmission mode, upon request for (4n+1)^{th}, (4n+2)^{th}, (4n+3)^{th}, (4n+4)^{th} retransmissions, and n is an integer.

15. The transmitter of claim 1, wherein if the number of the transmit antennas is 3, a coding matrix for the initial transmission mode is
$${B}_{3}^{( 0 )} = [ \begin{matrix}{s}_{1} & - {s}_{2}^{*} & {s}_{5} & - {s}_{6}^{*} \\ {s}_{2} & {s}_{1}^{*} & {s}_{6} & {s}_{5}^{*} \\ {s}_{7} & {s}_{8}^{*} & {s}_{3} & - {s}_{4}^{*}\end{matrix} ]$$
where s₁, s₂, s₃, s₄, s₅, s₆, s₇, and s₈ are input symbols.

16. The transmitter of claim 15, wherein data matrices for the permutation transmission mode are
$${B}_{3}^{( 3 n + 1 )} = [ \begin{matrix}0 & 1 & 0 \\ 0 & 0 & 1 \\ 1 & 0 & 0\end{matrix} ] {B}_{3}^{( 0 )}$$
$${B}_{3}^{( 3 n + 2 )} = [ \begin{matrix}0 & 0 & 1 \\ 1 & 0 & 0 \\ 0 & 1 & 0\end{matrix} ] {B}_{3}^{( 0 )}$$
$${B}_{3}^{( 3 n + 3 )} = [ \begin{matrix}1 & 0 & 0 \\ 0 & 1 & 0 \\ 0 & 0 & 1\end{matrix} ] {B}_{3}^{( 0 )}$$
where B₃⁽³ⁿ⁺¹⁾, B₃⁽³ⁿ⁺²⁾ and B₃⁽³ⁿ⁺³⁾ represent data matrices to be used for the permutation transmission mode, upon request for (3n+1)^{th}, (3n+2)^{th}, and (3n+3)^{th} retransmissions, and n is an integer.

17. A transmitter in a communication system using a plurality of transmit antennas, comprising:
an encoder for encoding input data in a predetermined coding scheme and outputting coded data;
a modulator for modulating the coded data in a predetermined modulation scheme and outputting modulated data;
a serial-to-parallel converter for converting the serial modulated data received from the modulator to parallel data; and
a space-time-block encoder for space-time-block encoding the parallel data and transmitting the space-time-block-coded data through the transmit antennas according to a permutation transmission mode with respect to an initial transmission mode, the permutation transmission mode being fed back from a receiver.

18. A transmission method in a communication system using a plurality of transmit antennas, comprising:
encoding input data in a predetermined coding scheme and outputting coded data;
modulating the coded data in a predetermined modulation scheme and outputting modulated data;
converting the serial modulated data to parallel data;
determining a permutation transmission mode with respect to an initial transmission mode, in response to a retransmission request fed back from a receiver; and
space-time-block encoding the parallel data and transmitting the space-time-block-coded data through the transmit antennas according to the permutation transmission mode.

19. The transmission method of claim 18, wherein if the number of the transmit antennas is N_{T}, a coding matrix for the initial transmission mode is
$${S}_{{N}_{T}}^{( 0 )} = [ \begin{matrix}{S}_{1} \\ {S}_{2} \\ ⋮ \\ {s}_{{N}_{T}}\end{matrix} ]$$
where s₁, s₂, and s_{NT} are input symbols.

20. The transmission method of claim 19, wherein upon request for a j^{th} retransmission, a coding matrix for the permutation transmission mode is determined by
S_{N}_{_{T}}^{(j)}=Π₍ⱼ₎(S_{N}_{_{T}}⁽⁰⁾)

21. The transmission method of claim 20, wherein if the number of the transmit antennas is 3, a coding matrix for the initial transmission mode is
$${S}_{3}^{( 0 )} = [ \begin{matrix}{s}_{1} \\ {s}_{2} \\ {s}_{3}\end{matrix} ]$$
where s₁, s₂, and s₃ are input symbols.

22. The transmission method of claim 21, wherein upon request for a j^{th} retransmission, a coding matrix for the permutation transmission mode is determined by
S₃^{(j)}=Π₍ⱼ₎(S₃⁽⁰⁾)

23. The transmission method of claim 18, wherein if the number of the transmit antennas is 4, a coding matrix for the initial transmission mode is
$${A}_{4}^{( 0 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ]$$
where s₁, . . . s₄, are input symbols.

24. The transmission method of claim 23, wherein data matrices for the permutation transmission mode are
$$\begin{matrix}{A}_{4}^{( 4 n + 1 )} = [ \begin{matrix}0 & 0 & {s}_{3} & - {s}_{4}^{*} \\ 0 & 0 & {s}_{4} & {s}_{3}^{*} \\ {s}_{1} & - {s}_{2}^{*} & 0 & 0 \\ {s}_{2} & {s}_{1}^{*} & 0 & 0\end{matrix} ] \\ {A}_{4}^{( 4 n + 2 )} = [ \begin{matrix}0 & 0 & {s}_{3} & - {s}_{4}^{*} \\ {s}_{1} & - {s}_{2}^{*} & 0 & 0 \\ 0 & 0 & {s}_{4} & {s}_{3}^{*} \\ {s}_{2} & {s}_{1}^{*} & 0 & 0\end{matrix} ] \\ {A}_{4}^{( 4 n + 3 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & 0 & 0 \\ 0 & 0 & {s}_{4} & {s}_{3}^{*}\end{matrix} ] \\ {A}_{4}^{( 4 n + 4 )} = [ \begin{matrix}{s}_{1} & - {s}_{2}^{*} & 0 & 0 \\ {s}_{2} & {s}_{1}^{*} & 0 & 0 \\ 0 & 0 & {s}_{3} & - {s}_{4}^{*} \\ 0 & 0 & {s}_{4} & {s}_{3}^{*}\end{matrix} ]\end{matrix}$$
where A₄⁽⁴ⁿ⁺¹⁾, A₄⁽⁴ⁿ⁺²⁾, A₄⁽⁴ⁿ⁺³⁾ and A₄⁽⁴ⁿ⁺⁴⁾ represent data matrices to be used for the permutation transmission mode, upon request for (4n+1)^{th}, (4n+2)^{th}, (4n+3)^{th}, (4n+4)^{th} retransmissions, and n is an integer.

25. The transmission method of claim 18, wherein if the number of the transmit antennas is 3, a coding matrix for the initial transmission mode is
$${A}_{3}^{( 0 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ]$$
where s₁, . . . s₄, are input symbols.

26. The transmission method of claim 25, wherein data matrices for the permutation transmission mode are
$$\begin{matrix}{A}_{3}^{( 3 n + 1 )} = [ \begin{matrix}{s}_{1} & - {s}_{2}^{*} & {s}_{3} & - {s}_{4}^{*} \\ {s}_{2} & - {s}_{1}^{*} & 0 & 0 \\ 0 & 0 & {s}_{4} & {s}_{3}^{*}\end{matrix} ] \\ {A}_{3}^{( 3 n + 2 )} = [ \begin{matrix}{s}_{1} & - {s}_{2}^{*} & 0 & 0 \\ 0 & 0 & {s}_{3} & - {s}_{4}^{*} \\ {s}_{2} & {s}_{1}^{*} & {s}_{4} & {s}_{3}^{*}\end{matrix} ] \\ {A}_{3}^{( 3 n + 3 )} = [ \begin{matrix}{s}_{1} & - {s}_{2}^{*} & 0 & 0 \\ {s}_{2} & {s}_{1}^{*} & {s}_{3} & - {s}_{4}^{*} \\ 0 & 0 & {s}_{4} & {s}_{3}^{*}\end{matrix} ]\end{matrix}$$
where A₃⁽³ⁿ⁺¹⁾, A₃⁽³ⁿ⁺²⁾ and A₃⁽³ⁿ⁺³⁾ represent data matrices to be used for the permutation transmission mode, upon request for (3n+1)^{th}, (3n+2)^{th}, and (3n+3)^{th} retransmissions, and n is an integer.

27. The transmission method of claim 18, wherein if the number of the transmit antennas is 4, a coding matrix for the initial transmission mode is
$${B}_{4}^{( 0 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ]$$
where s₁, . . . S₈, are input symbols.

28. The transmission method of claim 27, wherein data matrices for the permutation transmission mode are
$$\begin{matrix}{B}_{4}^{( 4 n + 1 )} = [ \begin{matrix}{s}_{3} & - {s}_{4}^{*} & {s}_{7} & {s}_{5}^{*} \\ {s}_{4} & {s}_{3}^{*} & {s}_{8} & {s}_{6}^{*} \\ {s}_{1} & - {s}_{2}^{*} & {s}_{5} & - {s}_{7}^{*} \\ {s}_{2} & {s}_{1}^{*} & {s}_{6} & - {s}_{8}^{*}\end{matrix} ] \\ {B}_{4}^{( 4 n + 2 )} = [ \begin{matrix}{s}_{1} & - {s}_{2}^{*} & {s}_{5} & - {s}_{7}^{*} \\ {s}_{3} & - {s}_{4}^{*} & {s}_{7} & {s}_{5}^{*} \\ {s}_{2} & {s}_{1}^{*} & {s}_{6} & - {s}_{8}^{*} \\ {s}_{4} & {s}_{3}^{*} & {s}_{8} & {s}_{6}^{*}\end{matrix} ] \\ {B}_{4}^{( 4 n + 3 )} = [ \begin{matrix}{s}_{3} & - {s}_{4}^{*} & {s}_{7} & {s}_{5}^{*} \\ {s}_{1} & - {s}_{2}^{*} & {s}_{5} & - {s}_{7}^{*} \\ {s}_{4} & {s}_{3}^{*} & {s}_{8} & {s}_{6}^{*} \\ {s}_{2} & {s}_{1}^{*} & {s}_{6} & - {s}_{8}^{*}\end{matrix} ] \\ {B}_{4}^{( 4 n + 4 )} = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ]\end{matrix}$$
where B₄⁽⁴ⁿ⁺¹⁾, B₄⁽⁴ⁿ⁺²⁾, B₄⁽⁴ⁿ⁺³⁾ and B₄⁽⁴ⁿ⁺⁴⁾ represent data matrices to be used for the permutation transmission mode, upon request for (4n+1)^{th}, (4n+2)^{th}, (4n+3)^{th}, (4n+4)^{th} retransmissions, and n is an integer.

29. The transmission method of claim 19, wherein if the number of the transmit antennas is 3, a coding matrix for the initial transmission mode is
$${B}_{3}^{( 0 )} = [ \begin{matrix}{s}_{1} & - {s}_{2}^{*} & {s}_{5} & - {s}_{6}^{*} \\ {s}_{2} & {s}_{1}^{*} & {s}_{6} & {s}_{5}^{*} \\ {s}_{7} & {s}_{8}^{*} & {s}_{3} & - {s}_{4}^{*}\end{matrix} ]$$

30. The transmission method of claim 29, wherein data matrices for the permutation transmission mode are
$$\begin{matrix}{B}_{3}^{( 3 n + 1 )} = [ \begin{matrix}0 & 1 & 0 \\ 0 & 0 & 1 \\ 1 & 0 & 0\end{matrix} ] {B}_{3}^{( 0 )} \\ {B}_{3}^{( 3 n + 2 )} = [ \begin{matrix}0 & 0 & 1 \\ 1 & 0 & 0 \\ 0 & 1 & 0\end{matrix} ] {B}_{3}^{( 0 )} \\ {B}_{3}^{( 3 n + 3 )} = [ \begin{matrix}1 & 0 & 0 \\ 0 & 1 & 0 \\ 0 & 0 & 1\end{matrix} ] {B}_{3}^{( 0 )}\end{matrix}$$
where B₃⁽³ⁿ⁺¹⁾, B₃⁽³ⁿ⁺²⁾ and B₃⁽³ⁿ⁺³⁾ represent data matrices to be used for the permutation transmission mode, upon request for (3n+1)^{th}, (3n+2)^{th}, and (3n+3)^{th} retransmissions, and n is an integer.

31. A transmission method in a communication system using a plurality of transmit antennas, comprising:
encoding input data in a predetermined coding scheme and outputting coded data;
modulating the coded data in a predetermined modulation scheme and outputting modulated data;
converting the serial modulated data to parallel data; and
space-time-block encoding the parallel data and transmitting the space-time-block-coded data through the transmit antennas according to a permutation transmission mode with respect to an initial transmission mode, the permutation transmission mode being fed back from a receiver.
